(19) United States
(12) Patent Application Publication
(10) Pub. No.: US 2007/0191555 A1
(43) Pub. Date: Aug. 16, 2007

(54) Thermosetting resin composition and its article

(76) Inventors: Hatsuo Ishida, Shaker Heights, OH (US); Koichi Shibayama, Osaka (JP); Hiroshi Abe, Osaka (JP)

Correspondence Address: TOWNSEND & BANTA;c/o PortfolioIP, P.O. Box 52050, Minneapolis, MN, 55402, US

(21) Appl. No.: 10/811,952

(22) Filed: Mar. 30, 2004

(51) Int. Cl. C08L 63/02; C08L 63/04

(52) U.S. Cl. 525/523

(57) ABSTRACT

The invention provides a thermosetting resin composition comprising a bifunctional dihydrobenzoxazine compound and an epoxy compound, and provides a thermosetting resin molding obtained by thermally curing the thermosetting resin composition. The molding has excellent electric properties of low dielectric constant and low dielectric loss tangent. The resin composition comprises an epoxy compound and a bifunctional dihydrobenzoxazine compound of the following general formula (1), wherein the equivalent ratio of the epoxy compound to the bifunctional dihydrobenzoxazine compound is 1/(0.1 to 20): 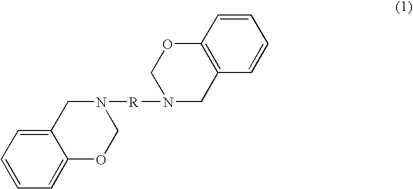 wherein R represents a linear alkylene group having at least 2 carbon atoms, or a branched alkylene group derived from it by substituting the hydrogen atom therein with an alkyl group, and the hydrogen atom of the benzene ring may be substituted with an alkyl group or an alkoxy group.

### BACKGROUND OF THE INVENTION

1. Field of the Invention

The present invention relates to a thermosetting resin composition that comprises a bifunctional dihydrobenzoxazine compound and an epoxy compound, and to a thermosetting resin molding that is obtained by thermally curing the thermosetting resin composition and has good electric properties of low dielectric constant and low dielectric loss tangent.

2. Description of the Related Art

Heretofore, thermosetting resins such as phenolic resin, melamine resin, epoxy resin, unsaturated polyester resin, bismaleimide resin and others are used in a wide variety of industrial fields as they have good heat resistance and reliability based on their thermosetting properties.

However, they have some drawbacks in that phenolic resin and melamine resin give volatile side products when cured, epoxy resin and unsaturated polyester resin are poorly resistant to flames, and bismaleimide resin is extremely expensive.

To solve these problems, recently, various dihydrobenzoxazine compounds, which thermally cure through ring-opening polymerization of the dihydrobenzoxazine ring thereof with no generation of volatile matters, have been extensively studied.

For example, in JP-A 2000-154225, a thermosetting resin is described which comprises a compound having a structure of the following general formula (3) and/or a ring-opening polymerization product thereof: 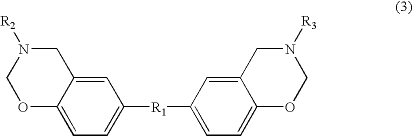
wherein R₁ represents a substituted or unsubstituted alicyclic hydrocarbon group having from 5 to 12 carbon atoms, a linear or branched alkylidene group having from 4 to 12 carbon atoms, or an aromatic hydrocarbon-substituted alkylidene group; R₂ and R₃ each represent an aliphatic group having at most 10 carbon atoms, a phenyl group, or a phenyl group that is ortho- or para-substituted with a t-butyl group, and they may be the same or different.

A dihydrobenzoxazine compound having the following structural formula (4) is commercially sold by Shikoku Kasei Kogyo KK as a trade name of “Monomer for Thermosetting Resin, B-a Type Benzoxazine”:

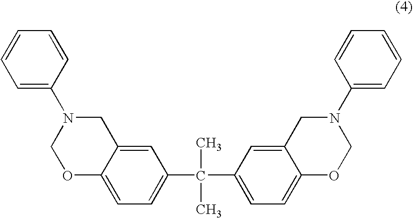

However, the above-mentioned dihydrobenzoxazine compound is so designed that the two benzene rings each forming the benzoxazine ring therein bond to each other via a substituted or unsubstituted alicyclic hydrocarbon group having from 5 to 12 carbon atoms, a linear or branched alkylidene group having from 4 to 12 carbon atoms or an aromatic hydrocarbon-substituted alkylidene group existing between them, and therefore, the moldings obtained by thermally curing the compound are hard and brittle as their elongation and flexibility are low though their flexural strength and flexural modulus are high. Accordingly, it is difficult to use the compound for moldings, especially for thin moldings such as laminates or films.

Therefore, for producing laminates, a method of thermally curing a mixture of the above-mentioned dihydrobenzoxazine compound and an epoxy resin to give moldings has been investigated. However, the resulting moldings are still brittle since their elongation and flexibility are unsatisfactory, and therefore they are unfavorable to laminates. Accordingly, it is desired to develop moldings of a dihydrobenzoxazine compound that satisfy good elongation and flexibility.

On the other hand, in U.S. Pat. No. 5,543,516, a method for producing a bifunctional dihydrobenzoxazine compound of the following general formula (1) is described. 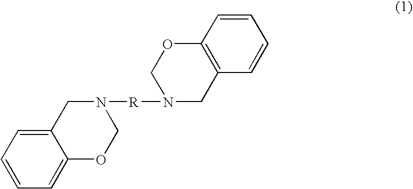
wherein R represents a linear alkylene group having at least 2 carbon atoms, or a branched alkylene group derived from it by substituting the hydrogen atom therein with an alkyl group, and the hydrogen atom of the benzene ring may be substituted with an alkyl group or an alkoxy group.

The bifunctional dihydrobenzoxazine compound has two benzoxazine rings, in which the two benzoxazine rings bond to each other at the nitrogen atom of each ring via the alkylene group existing therebetween, and the structure of the compound entirely differs from that of the dihydrobenzoxazine compound of formula (3).

When this is heated like the dihydrobenzoxazine compound of formula (3), then the benzoxazine rings therein undergo ring-opening polymerization and the compound thereby thermally cures with no generation of volatile matters. However, U.S. Pat. No. 5,543,516 has no description at all relating to ring-opening polymerization of the bifunctional dihydrobenzoxazine compound and to the polymer of derived from the compound.

In U.S. Pat. No. 6,207,786, described is a ternary composition comprising from about 10 to about 80% by weight of a benzoxazine monomer, from about 10 to about 80% by weight of an epoxy resin and from about 1 to about 80% by weight of a phenolic resin, wherein the benzoxazine monomer has at least two benzoxazine rings per molecule. The US patent says that the benzoxazine monomer is produced according to the production method described in the above-mentioned U.S. Pat. No. 5,543,516.

In U.S. Pat. No. 6,207,786, however, described in only a ternary composition comprising the above-mentioned “B-a type benzoxazine”, an epoxy resin and a phenolic resin.

Specifically, at present, no study is made at all relating to ring-opening polymerization of the bifunctional dihydrobenzoxazine compound of formula (1) and to a ring-opened polymer thereof.

### SUMMARY OF THE INVENTION

An object of the invention is to provide a thermosetting resin composition containing a bifunctional dihydrobenzoxazine compound and capable of giving thermosetting resin moldings having a low dielectric constant and having well-balanced physical properties of tensile strength at break, elasticity, elongation and flexibility.

Another object of the invention is to provide a thermosetting resin molding having a low dielectric constant and having well-balanced physical properties of tensile strength at break, elasticity, elongation and flexibility, by thermally curing the above-mentioned thermosetting resin composition.

### DETAILED DESCRIPTION OF THE INVENTION

The thermosetting resin composition of the invention comprises an epoxy compound and a bifunctional dihydrobenzoxazine compound of the following general formula (1), wherein the equivalent ratio of the epoxy compound to the bifunctional dihydrobenzoxazine compound is 1/(0.1 to 20): 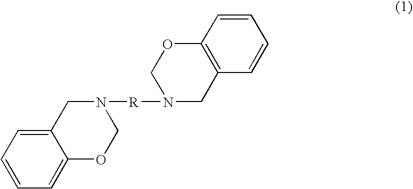
wherein R represents a linear alkylene group having at least 2 carbon atoms, or a branched alkylene group derived from it by substituting the hydrogen atom therein with an alkyl group, and the hydrogen atom of the benzene ring may be substituted with an alkyl group or an alkoxy group.

The epoxy compound for use in the invention is preferably a bifunctional or higher polyfunctional epoxy compound and may be any ordinary one, including, for example, glycidyl ether-type epoxy compounds, glycidyl ester-type epoxy compounds, glycidylamine-type epoxy compounds and alicyclic epoxy compounds.

More specifically, their examples are bisphenol A-type epoxy compounds, bisphenol F-type epoxy compounds, bisphenol S-type epoxy compounds, alicyclic epoxy compounds, phenol-novolac-type epoxy compounds, cresol-novolac-type epoxy compounds, phenol A-novolac-type epoxy compounds, polyfunctional phenol diglycidyl ethers, butadiene-type epoxy compounds, and their hydrogenated derivatives. One or more of these may be used herein either singly or as combined.

In the bifunctional dihydrobenzoxazine compound of formula (1), R is a linear alkylene group having at least 2 carbon atoms, or a branched alkylene group derived from it by substituting the hydrogen atom therein with an alkyl group.

With the decrease in the number of the carbon atoms that constitute the linear alkylene group in the compound, the Young's modulus and the glass transition temperature of the moldings of the resin composition may increase but the elongation and the flexibility thereof decrease. On the contrary, with the increase in the number of the carbon atoms, the elongation and the flexibility of the moldings may increase but the Young's modulus and the tensile strength at break thereof decrease. Accordingly, the number of the carbon atoms is preferably from 2 to 16, more preferably from 2 to 12.

R may also be a branched alkylene group derived from a linear alkylene group having at least 2 carbon atoms, by substituting the hydrogen atom therein with an alkyl group. The alkyl substitution in the group may increase the modulus of elasticity and the tensile strength at break of the moldings of the resin composition, but the elongation and the flexibility thereof decrease. Therefore, the number of the carbon atoms that constitute the backbone, linear alkylene group and the degree of alkyl substitution in the group must be well balanced.

Specifically, when the number of the carbon atoms constituting the linear alkylene group is large, then it is desirable that the group is substituted with an alkyl group. The alkyl group includes, for example, methyl, ethyl, propyl and butyl groups.

The hydrogen atoms of the benzene ring in the bifunctional dihydrobenzoxazine compound of formula (1) may be substituted with an alkyl group or an alkoxy group. The alkyl group includes, for example, methyl, ethyl, propyl, butyl, octyl and nonyl groups; and the alkoxy group includes, for example, methoxy, ethoxy, propoxy and butoxy groups.

Preferably, the bifunctional dihydrobenzoxazine compound of formula (1) is produced from a monophenol compound, an aliphatic diamine of the following general formula (2), and a formaldehyde compound.
H₂N—R—NH₂ (2)
wherein R represents a linear alkylene group having at least 2 carbon atoms, or a branched alkylene group derived from it by substituting the hydrogen atom therein with an alkyl group.

The monophenol compound is a compound that has one phenolic hydroxyl group and has a hydrogen atom in at least one ortho-position thereof. For example, it includes phenol, cresol, xylenol, nonylphenyl, p-t-butylphenol, and octylphenol.

R in the aliphatic diamine of formula (2) is the same as R in the bifunctional dihydrobenzoxazine compound of formula (1). For example, the diamine includes 1,2-diaminoethylene, 1,3-diaminopropane, 1,4-diaminobutane, 1,6-diaminohexane, 1,8-diaminooctane, and 1,12-diaminododecane.

The formaldehyde compound includes, for example, formalin, an aqueous solution of formaldehyde, and paraformaldehyde, and a polymer of formaldehyde.

The bifunctional dihydrobenzoxazine compound of formula (1) may be produced by reacting 2 moles of a monophenol compound, 1 mole of an aliphatic diamine of formula (2) and 4 moles of a formaldehyde compound, and any known method may be employed for producing it.

For example, as in U.S. Pat. No. 5,543,516, 2 moles of a monophenol compound, one mole of an aliphatic diamine of formula (2) and 4 moles of a formaldehyde compound are mixed, and stirred for 10 minutes to 1 hour while heated at 100 to 130° C. In that manner, the compound may be produced with ease.

As the case may be, the compound may also be produced by dissolving the starting compounds in a lower alcohol such as methanol, ethanol, propanol or butanol, or in any other solvent such as acetone, methyl ethyl ketone, toluene, xylene, dimethylsulfoxide, 1,4-dioxane, ethylene glycol monomethyl ether, ethylene glycol monoethyl ether or ethylene glycol monobutyl ether.

In this case, the starting compounds may be reacted for 2 to 6 hours while heated at 100 to 130° C. After the reaction, the solvent is removed, and if desired, the reaction product is then washed with alkali to thereby remove the non-reacted monophenol, aliphatic diamine and formaldehyde.

In the thermosetting resin composition of the invention, the oxazine rings in the bifunctional dihydrobenzoxazine compound of formula (1) are cleaved to give hydroxyl groups, and the resulting compound then serves as a curing agent for the epoxy compound in the composition. Theoretically, when the equivalent ratio of the epoxy compound to the bifunctional dihydrobenzoxazine compound is 1/1, then all the hydroxyl groups derived from the bifunctional dihydrobenzoxazine compound shall react with the epoxy groups of the epoxy compound.

However, with the increase in the proportion of the epoxy compound in the composition, the dielectric loss tangent of the moldings of the composition may increase; but on the contrary, with the increase in the proportion of the bifunctional dihydrobenzoxazine compound in the composition, the modulus of elasticity of the moldings may increase while the elongation and the flexibility thereof may decrease. Accordingly, the equivalent ratio of the epoxy compound to the bifunctional dihydrobenzoxazine compound should be 1/(0.1 to 20), preferably 1/(0.5 to 10).

One equivalent of the epoxy compound is the weight-average molecular weight thereof per one oxirane ring in the epoxy compound. In other words, it is a value obtained by dividing the weight-average molecular weight of the epoxy compound by the number of the oxirane rings in the compound.

One equivalent of the bifunctional dihydrobenzoxazine compound is the molecular weight thereof per one oxazine ring in the bifunctional dihydrobenzoxazine compound. In other words, it is a value obtained by dividing the molecular weight of the bifunctional dihydrobenzoxazine compound by the number of the oxazine rings in the compound (the number is 2 in the bifunctional dihydrobenzoxazine compound).

If desired, an organic solvent may be added to the thermosetting resin composition of the invention, and the resulting composition is a varnish. The organic solvent may be any one capable of dissolving the bifunctional dihydrobenzoxazine compound of formula (1) and an epoxy compound, and includes, for example, alcohols such as methanol, ethanol, isopropyl alcohol; ketones such as acetone, methyl ethyl ketone, cyclohexanone; and toluene, xylene, ethylbenzene, dimethylformamide and N-methylpyrrolidone. One or more of these may be used herein either singly or as combined.

Thermally molding the thermosetting resin composition gives a thermosetting resin molding of the composition. Specifically, when the thermosetting resin composition is heated, then the oxazine rings in the bifunctional dihydrobenzoxazine compound of formula (1) therein are cleaved to give hydroxyl groups and the resulting hydroxyl groups react with the epoxy groups in the epoxy compound, whereby the composition is cured into a thermosetting resin molding.

For thermally molding the composition, employable is any known method generally employed for polymerizing ordinary bifunctional dihydrobenzoxazine compounds. In general, for example, the composition may be heated for a few hours at 120 to 260° C. However, if the heating temperature is too low or the heating time is too short, then the glass transition temperature of the resulting moldings could not be high and the heat resistance and the mechanical strength thereof may be low. However, if the heating temperature is too high or the heating time is too long, then the glass transition temperature of the resulting moldings will lower and the heat resistance and the mechanical strength thereof will also lower. Accordingly, it is desirable that the composition is thermally molded at 165 to 250° C. for 0.5 to 5 hours.

For obtaining thermosetting resin moldings having a uniform and good surface appearance and having high mechanical strength, it is desirable that the composition is pre-heated at a low temperature before it is thermally molded in the manner as above. Preferably, the composition is pre-heated at a temperature not lower than 130° C. but lower than 165° C. for 0.5 to 5 hours.

Electronic appliances are now required to satisfy high-density packaging, high-speed signal transmittability and high-frequency applicability, and laminate boards and other electronic materials for them are therefore required to have a reduced dielectric constant. In particular, for multi-layered substrates for IC packages, it is desirable that the above-mentioned thermosetting resin moldings have a dielectric constant of at most 3.5 and a dielectric loss tangent of at most 0.015 at 23° C. at 1 GHz.

When the thermosetting resin moldings are used for electronic materials such as laminate boards, then it is desirable that they are self-sustainable and are relatively flexible, and are not brittle. More specifically, it is desirable that they are not broken even when they have received a force to such a degree that they may be deformed by the force, and therefore they can be used even in stress-bearing or moving parts. Accordingly, it is desirable that the moldings have a Young's modulus at 23° C. from 0.5 to 5.5 GPa and an elongation at break at 23° C. from 2.0 to 40%.

In the invention, the dielectric constant and the dielectric loss tangent are measured as follows:

A sheet-like molding obtained by thermally curing the thermosetting resin composition is cut into a piece of 15 mm×15 mm, this is set in a dielectric constant meter and analyzed therein at 23° C., and the data-of the dielectric constant and the dielectric loss tangent of the sample at 1 GHz are read.

In the invention, the Young's modulus and the elongation at break are measured as follows:

A sheet-like molding obtained by thermally curing the thermosetting resin composition is cut into a piece of 80 mm×10 mm, and this is set in a tensile tester and tested at 23° C. to determine the Young's modulus and the elongation at break of the sample. The chuck-to-chuck distance is 60 mm, and the crosshead speed is 5 mm/min.

The thermosetting resin composition of the invention may contain a curing agent for epoxy compound for more efficiently curing the epoxy compound therein.

The curing agent for epoxy compound may be any one heretofore generally used as a curing agent for epoxy compound. For example, it includes amine compounds, compounds to be produced from amine compounds such as polyaminoamide compounds, as well as tertiary amine compounds, imidazole compounds, hydrazide compounds, melamine compounds, acid anhydrides, phenolic compounds, thermo-latent cationic polymerization catalysts, photo-latent cationic polymerization initiators, dicyandiamide and its derivatives. One or more of these curing agents may be used herein either singly or as combined.

The amine compounds include, for example, linear aliphatic amines and their derivatives, such as ethylenediamine, diethylenetriamine, triethylenetetramine, tetraethylenepentamine, diethylaminopropylamine, methylenedianiline, benzylmethylamine, polyoxypropylenediamine, polyoxypropylenetriamine; cycloaliphatic amines and their derivatives, such as menthenediamine, isophoronediamine, bis(4-amino-3-methylcyclohexyl)methane, diaminodicyclohexylmethane, bis(aminomethyl)cyclohexane, N-aminoethylpiperazine, 3,9-bis(3-aminopropyl)-2,4,8,10-tetraoxaspiro(5,5)undecane, aminoethylpiperazine; aromatic amines and their derivatives, such as m-xylenediamine, diaminodiphenylmethane, diaminodiphenyl sulfone, metaphenylenediamine, α-(m/p-aminophenyl)ethylamine, m-phenylenediamine, diaminodiphenylmethane, diaminodiphenyl sulfone, α,α-bis(4-aminophenyl-p-diisopropylbenzene).

Compounds to be produced from the above-mentioned amine compounds are, for example, polyaminoamide compounds and their derivatives that are produced from the amine compounds and carboxylic acid compounds such as succinic acid, adipic acid, azelaic acid, sebacic acid, dodecane-diacid, isophthalic acid, terephthalic acid, dihydroisophthalic acid, tetrahydroisophthalic acid, hexahydroisophthalic acid; polyaminoimide compounds and their derivatives that are produced from the amine compounds and maleimide compounds such as diaminodiphenylmethane-bismaleimide; ketimine compounds and their derivatives that are produced from the amine compounds and ketone compounds; and polyamino compounds and their derivatives that are produced from the amine compounds and other compounds such as epoxy compounds, urea, thiourea, aldehyde compounds, phenolic compounds and acrylic compounds.

The tertiary amine compounds include, for example, N, N-dimethylpiperazine, pyridine, picoline, benzyldimethylamine, 2-(dimethylaminomethyl)phenol, 2,4,6-tris (dimethylaminomethyl)phenol, 1,8-diazabiscyclo (5,4,0) undecene-1, and their derivatives.

The imidazole compounds include, for example, 2-methylimidazole, 2-ethyl-4-methylimidazole, 2-undecylimidazole, 2-heptadecylimidazole, 2-phenylimidazole, and their derivatives.

The hydrazide compounds are not specifically defined, including, for example, 1,3-bis(hydrazinocarboethyl)-5-isopropylhydantoin, 7,11-octadecadiene-1,18-dicarbohydrazide, eicosane-diacid dihydrazide, adipic acid dihydrazide, and their derivatives.

The melamine compounds include, for example, 2,4-diamino-6-vinyl-1,3,5-triazine and its derivatives.

The acid anhydrides include, for example, phthalic acid anhydride, trimellitic acid anhydride, pyromellitic acid anhydride, benzophenonetetracarboxylic acid anhydride, ethylene glycol bisanhydrotrimellitate, glycerol trisanhydrotrimellitate, methyltetrahydrophthalic acid anhydride, tetrahydrophthalic acid anhydride, nadic acid anhydride, methylnadic acid anhydride, trialkyltetrahydrophthalic acid anhydride, hexahydrophthalic acid anhydride, methylhexahydrophthalic acid anhydride, 5-(2,5-dioxotetrahydrofuryl-3-methyl-3-cyclohexene-1,2-dica rboxylic acid anhydride, trialkyltetrahydrophthalic acid anhydride-maleic acid anhydride adduct, dodecenylsuccinic acid anhydride, polyazelaic acid anhydride, polydodecane-diacid anhydride, chlorendic acid anhydride, and their derivatives.

The phenolic compounds are not specifically defined, including, for example, phenol-novolac, o-cresol-novolac, p-cresol-novolac, t-butylphenol-novolac, dicyclopentadiene-cresol, and their derivatives.

In the thermosetting resin composition comprising an epoxy compound, a bifunctional dihydrobenzoxazine compound of formula (1) and a curing agent for epoxy compound, both the bifunctional dihydrobenzoxazine compound and the curing agent for epoxy compound act on the epoxy compound to cure it. In the composition, therefore, the amount of the bifunctional dihydrobenzoxazine compound may be reduced relative to the curing agent for epoxy compound added to the composition.

However, with the increase in the amount of the epoxy compound in the composition, the dielectric loss tangent of the moldings of the composition may increase; and with the increase in the proportion of the bifunctional dihydrobenzoxazine compound therein, the modulus of elasticity of the moldings may increase but the elongation and the flexibility thereof may lower. Therefore, the equivalent ratio of the epoxy compound to the bifunctional dihydrobenzoxazine compound is preferably 1/(0.1 to 20), and the equivalent ratio of the epoxy compound to the curing agent for epoxy compound is preferably 1/(0 to 1.2), more preferably 1/(0.1 to 1.0).

Accordingly, the equivalent ratio of epoxy compound/bifunctional dihydrobenzoxazine compound/curing agent for epoxy compound is preferably 1/(0.1 to 20)/(0 to 1.2), more preferably 1/(0.5 to 10)/(0.1 to 1.0).

In this case, the total of the equivalent proportion of the bifunctional dihydrobenzoxazine compound and the equivalent proportion of the curing agent for epoxy compound is preferably at least 0.9 times the equivalent proportion of the epoxy compound. In other words, it is desirable that the sum total of the number of the functional groups in the bifunctional dihydrobenzoxazine compound and the number of the functional groups in the curing gent for epoxy compound is at least 0.9 times the number of the functional groups in the epoxy compound.

One equivalent of the curing agent for epoxy compound is the weight-average molecular weight thereof per one functional group capable of reacting with an oxirane ring, in the curing agent for epoxy compound. In other words, it is a value obtained by dividing the weight-average molecular weight of the curing agent for epoxy compound, by the number of the functional groups capable of reacting with an oxirane ring, in the curing agent.

Thermally molding the thermosetting resin composition that comprises the above-mentioned epoxy compound, bifunctional dihydrobenzoxazine compound of formula (1) and curing agent for epoxy compound gives a thermosetting resin molding of the composition. For the method for thermally molding it, referred to be the description given herein above.

For the same reasons as those mentioned herein above for their electric properties, the thermosetting resin moldings thus obtained from the composition preferably have a dielectric constant of at most 3.5 and a dielectric loss tangent of at most 0.015 at 23° C. at 1 GHz.

When the thermosetting resin moldings are used for electronic materials such as laminate boards, then it is desirable that they are able to self-support and are relatively flexible, and are not brittle. More specifically, it is desirable that they are not broken even when they have received a force to such a degree that they may be deformed by the force, and therefore they can be used even in stress-bearing or moving parts. Accordingly, it is desirable that the moldings have a Young's modulus at 23° C. from 0.5 to 5.5 GPa and an elongation at break at 23° C. from 2.0 to 40%.

Also if desired, an inorganic filler may be added to the thermo setting resin composition of the invention for controlling the viscosity of the composition, and for improving the mechanical properties, the electric properties and the thermal properties of the thermosetting resin moldings of the resulting composition.

The inorganic filler may be any one heretofore used in molding thermosetting resin. For example, it includes calcium carbonate, magnesium carbonate, silicon oxide, aluminum oxide, titanium oxide, magnesium hydroxide, aluminum hydroxide, calciumhydroxide, bariumsulfate, magnesiumsulfate, mica, talc, clay, zeolite, and carbon black.

If the amount of the inorganic filler in the composition is too large, then the elongation of the thermosetting resin moldings of the composition may lower and the moldings may be brittle. Therefore, the amount of the inorganic filler is preferably at most 400 parts by weight, more preferably at most 200 parts by weight relative to 100 parts by weight of the resin component in the composition.

Accordingly, in the thermosetting resin composition that comprises an epoxy compound, a bifunctional dihydrobenzoxazine compound of formula (1) and an inorganic filler, the equivalent ratio of the epoxy compound to the bifunctional dihydrobenzoxazine compound is preferably 1/(0.1 to 20), and the amount of the inorganic filler is preferably at most 400 parts by weight, more preferably at most 200 parts by weight relative to 100 parts by weight of the total of the epoxy compound and the bifunctional dihydrobenzoxazine compound.

Thermally molding the thermosetting resin composition that comprises the above-mentioned epoxy compound, bifunctional dihydrobenzoxazine compound of formula (1) and inorganic filler gives a thermosetting resin molding of the composition. For the method for thermally molding it, referred to be the description given herein above.

For the same reasons as those mentioned herein above for their electric properties, the thermo setting resin moldings thus obtained from the composition preferably have a dielectric constant of at most 3.5 and a dielectric loss tangent of at most 0.015 at 23° C. at 1 GHz.

When the thermosetting resin moldings are used for electronic materials such as laminate boards, then it is desirable that they are able to self-support and are relatively flexible, and are not brittle. More specifically, it is desirable that they are not broken even when they have received a force to such a degree that they may be deformed by the force, and therefore they can be used even in stress-bearing or moving parts. Accordingly, it is desirable that the moldings have a Young's modulus at 23° C. from 0.5 to 5.5 GPa and an elongation at break at 23° C. from 2.0 to 40%.

Also if desired, the thermosetting resin composition of the invention may contain both the curing agent for epoxy compound and the inorganic filler. Accordingly, the composition of the type comprises an epoxy compound, a bifunctional dihydrobenzoxazine compound of formula (1), a curing agent for epoxy compound and an inorganic filler, in which the equivalent ratio of epoxy compound/bifunctional dihydrobenzoxazine compound/curing agent for epoxy compound is preferably 1/(0.1 to 20)/(0 to 1.2), and the amount of the inorganic filler is preferably at most 400 parts by weight, more preferably at most 200 parts by weight relative to 100 parts by weight of the total of the epoxy compound, the bifunctional dihydrobenzoxazine compound and the curing agent for epoxy compound.

Thermally molding the thermosetting resin composition that comprises the above-mentioned epoxy compound, bifunctional dihydrobenzoxazine compound of formula (1) and inorganic filler gives a thermosetting resin molding of the composition. For the method for thermally molding it, referred to be the description given herein above.

For the same reasons as those mentioned herein above for their electric properties, the thermosetting resin moldings thus obtained from the composition preferably have a dielectric constant of at most 3.5 and a dielectric loss tangent of at most 0.015 at 23° C. at 1 GHz.

When the thermosetting resin moldings are used for electronic materials such as laminate boards, then it is desirable that they are able to self-support and are relatively flexible, and are not brittle. More specifically, it is desirable that they are not broken even when they have received a force to such a degree that they may be deformed by the force, and therefore they can be used even in stress-bearing or moving parts. Accordingly, it is desirable that the moldings have a Young's modulus at 23° C. from 0.5 to 5.5 GPa and an elongation at break at 23° C. from 2.0 to 40%.

Also if desired, a curing promoter for the bifunctional dihydrobenzoxazine compound may be added to the resin composition of the invention. The curing promoter may be any one generally used for processing bifunctional dihydrobenzoxazine compounds for ring-opening polymerization thereof. For example, it includes polyfunctional phenols such as catechol, bisphenol A; sulfonic acids such as p-toluenesulfonic acid, p-phenolsulfonic acid; carboxylic acids such as benzoic acid, salicylic acid, oxalic acid, adipic acid; metal complexes such as cobalt (II) acetylacetate, aluminum (III) acetylacetate, zirconium (IV) acetylacetonate; metal oxides such as calciumoxide, cobalt oxide, magnesium oxide, iron oxide; calcium hydroxide, imidazole and its derivatives; tertiary amines such as diazabicycloundecene, diazabicyclononene, and their salts; phosphorus compounds and their derivatives, such as triphenyl phosphine, triphenylphosphine-benzoquinone derivative, triphenylphosphine-triphenylboron salt, tetraphenylphosphoniumtetraphenylborate. One or more of these may be used herein either singly or as combined.

The amount of the curing promoter to be added to the resin composition is not specifically defined. However, if too much is added, the curing promoter may have some negative influences on the mechanical properties of the moldings of the composition. In general, therefore, the amount of the curing promoter may be at most 5 parts by weight, preferably at most 3 parts by weight relative to 100 parts by weight of the bifunctional dihydrobenzoxazine compound in the composition.

The constitution of the thermosetting resin composition of the invention is described herein above. The thermosetting resin moldings to be obtained by thermally molding the thermosetting resin composition have a low dielectric constant, and have well-balanced physical properties of tensile strength at break, elasticity, elongation and flexibility.

### EXAMPLES

Examples of the invention are described below, to which, however, the invention should not be limited.

Production of Bifunctional Dihydrobenzoxazine Compounds

(1) One mol of 1,2-diaminoethane, 2 moles of phenol and 4 moles of paraformaldehyde were mixed and heated at 100° C. After the resulting mixture became a uniform transparent liquid, it was further heated to 120° C. while stirring, and reacted for 30 minutes to give a bifunctional dihydrobenzoxazine compound of formula (1) where R is an ethylene group (this is hereinafter referred to as “benzoxazine compound (C2)”).

(2) One mole of 1,8-diaminooctane, 2 moles of phenol and 4 moles of paraformaldehyde were mixed and heated at 100° C. After the resulting mixture became a uniform transparent liquid, it was further heated to 120° C. while stirring, and reacted for 30 minutes to give a bifunctional dihydrobenzoxazine compound of formula (1) where R is an octane group (this is hereinafter referred to as “benzoxazine compound (C8)”).

### Example 1

Thirty seven parts by weight of a liquid bisphenol A-type epoxy compound (trade name “D.E.R. 331L” by Dow Chemical Japan), 63 parts by weight of the benzoxazine compound (C2), 160 parts by weight of toluene and 70 parts by weight of ethylbenzene were fed into a homogenizer (trade name “T.K. Homodisper”, by Tokushu Kika Kogyo), stirred therein at 3,000 rpm for 30 minutes, and then deformed to give a thermo setting resin composition solution. The equivalent ratio of the liquid bisphenol A-type epoxy compound to the benzoxazine compound (C2) was 1/2.

Thus obtained, the thermosetting resin composition solution was fed into a mold having a length of 100 mm, a width of 20 mm and a depth of 1 mm. After toluene and ethylbenzene were evaporated, this was heated at 140° C. for 1 hour, then at 160° C. for 1 hour and finally at 180° C. for 2 hours to obtain a sheet-like molding having a length of 100 mm, a width of 20 mm and a thickness of 100 μn.

### Example 2

Thirty two parts by weight of a liquid bisphenol A-type epoxy compound (trade name “D.E.R. 331L” by DowChemical Japan), 68 parts by weight of the benzoxazine compound (C8), 160 parts by weight of toluene and 70 parts by weight of ethylbenzene were fed into a homogenizer (trade name “T.K. Homodisper”, by Tokushu Kika Kogyo), stirred therein at 3,000 rpm for 30 minutes, and then deformed to give a thermo setting resin composition solution. The equivalent ratio of the liquid bisphenol A-type epoxy compound to the benzoxazine compound (C8) was 1/2.

Thus obtained, the thermosetting resin composition solution was fed into a mold having a length of 100 mm, a width of 20 mm and a depth of 1 mm. After toluene and ethylbenzene were evaporated, this was heated at 140° C. for 1 hour, then at 160° C. for 1 hour and finally at 180° C. for 2 hours to obtain a sheet-like molding having a length of 100 mm, a width of 20 mm and a thickness of 100 μm.

### Example 3

Thirty eight parts by weight of a polybutadiene-type epoxy compound (trade name “Epolead PB3600 by Daicel Chemical), 62 parts by weight of the benzoxazine compound (C2), 160 parts by weight of toluene and 70 parts by weight of ethylbenzene were fed into a homogenizer (trade name “T.K. Homodisper”, by Tokushu Kika Kogyo), stirred therein at 3,000 rpm for 30 minutes, then deformed to give a thermosetting resin composition solution. The equivalent ratio of the polybutadiene-type epoxy compound to the benzoxazine compound (C2) was 1/2.

Thus obtained, the thermosetting resin composition solution was fed into a mold having a length of 100 mm, a width of 20 mm and a depth of 1 mm. After toluene and ethylbenzene were evaporated, this was heated at 140° C. for 1 hour, then at 160° C. for 1 hour and finally at 180° C. for 2 hours to obtain a sheet-like molding having a length of 100 mm, a width of 20 mm and a thickness of 100 μm.

### Example 4

Fifty four parts by weight of a liquid bisphenol A-type epoxy compound (trade name “D.E.R. 331L” by Dow Chemical Japan), 46 parts by weight of the benzoxazine compound (C2), 11 parts by weight of synthetic smectite (trade name “SAN” by Corp Chemical), 178 parts by weight of toluene and 78 parts by weight of ethylbenzene were fed into a homogenizer (trade name “T.K. Homodisper”, by Tokushu Kika Kogyo), stirred therein at 3,000 rpm for 30 minutes, and then deformed to give a thermosetting resin composition solution. The equivalent ratio of the liquid bisphenol A-type epoxy compound to the benzoxazine compound (C2) was 1/1.

Thus obtained, the thermosetting resin composition solution was fed into a mold having a length of 100 mm, a width of 20 mm and a depth of 1 mm. After toluene and ethylbenzene were evaporated, this was heated at 140° C. for 1 hour, then at 160° C. for 1 hour and finally at 180° C. for 2 hours to obtain a sheet-like molding having a length of 100 mm, a width of 20 mm and a thickness of 100 μm.

### Example 5

Thirty seven parts by weight of a liquid bisphenol A-type epoxy compound (trade name “D.E.R. 331L” by Dow Chemical Japan), 63 parts by weight of the benzoxazine compound (C2), 11 parts by weight of synthetic smectite (trade name “SAN” by Corp Chemical), 178 parts by weight of toluene and 78 parts by weight of ethylbenzene were fed into a homogenizer (trade name “T.K. Homodisper”, by Tokushu Kika Kogyo), stirred therein at 3,000 rpm for 30 minutes, and then deformed to give a thermosetting resin composition solution. The equivalent ratio of the liquid bisphenol A-type epoxy compound to the benzoxazine compound (C2) was 1/2.

Thus obtained, the thermosetting resin composition solution was fed into a mold having a length of 100 mm, a width of 20 mm and a depth of 1 mm. After toluene and ethylbenzene were evaporated, this was heated at 140° C. for 1 hour, then at 160° C. for 1 hour and finally at 180° C. for 2 hours to obtain a sheet-like molding having a length of 100 mm, a width of 20 mm and a thickness of 100 μm.

### Example 6

Fifteen parts by weight of a polybutadiene-type epoxy compound (trade name “Epolead PB3600 by Daicel Chemical), 85 parts by weight of the benzoxazine compound (C2), 11 parts by weight of synthetic smectite (trade name “SAN” by Corp Chemical), 178 parts by weight of toluene and 78 parts by weight of ethylbenzene were fed into a homogenizer (trade name “T.K. Homodisper”, by Tokushu Kika Kogyo), stirred therein at 3,000 rpm for 30 minutes, then deformed to give a thermosetting resin composition solution. The equivalent ratio of the polybutadiene-type epoxy compound to the benzoxazine compound (C2) was 1/7.

Thus obtained, the thermosetting resin composition solution was fed into a mold having a length of 100 mm, a width of 20 mm and a depth of 1 mm. After toluene and ethylbenzene were evaporated, this was heated at 140° C. for 1 hour, then at 160° C. for 1 hour and finally at 180° C. for 2 hours to obtain a sheet-like molding having a length of 100 mm, a width of 20 mm and a thickness of 100 μm.

### Comparative Example 1

Ninety three and a half parts by weight of a liquid bisphenol A-type epoxy compound (trade name “D.E.R. 331L” by Dow Chemical Japan), 6.5 parts by weight of dicyandiamide (trade name “CG-1200” by B.T.I. Japan), 2parts by weight of a curing catalyst (trade name “Curesol 2E4HZ” by Shikoku Kasei), 163 parts by weight of toluene and 71 parts by weight of ethylbenzene were fed into a homogenizer (trade name “T.K. Homodisper”, by Tokushu Kika Kogyo), stirred therein at 3,000 rpm for 30 minutes, and then deformed to give a thermosetting resin composition solution.

Thus obtained, the thermosetting resin composition solution was fed into a mold having a length of 100 mm, a width of 20 mm and a depth of 1 mm. After toluene and ethylbenzene were evaporated, this was heated at 110° C. for 3 hours and further at 160° C. for 3 hours to obtain a sheet-like molding having a length of 100 mm, a width of 20 mm and a thickness of 100 μm.

The sheet-like moldings obtained in Examples 1 to 6 and Comparative Example 1 were analyzed to measure the dielectric constant, the dielectric loss tangent, the Young's modulus, the elongation at break, the tensile strength at break and the thermal expansion coefficient thereof. The data obtained are given in Table 1. The physical properties were measured as follows:
(1) Dielectric constant, and dielectric loss tangent:

The sheet-like molding is cut into a piece of 15 mm×15 mm, this is set in a dielectric constant meter (trade code “HP4291B” by Hewlett Packard) and analyzed therein at 23° C., and the data of the dielectric constant and the dielectric loss tangent of the sample at 1 GHz are read.
(2) Young's modulus, elongation at break, and tensile strength at break:

The sheet-like molding is cut into a piece of 80 mm×10 mm, and this is set in a tensile tester (trade name “Tensilon” by Orientec) and tested at 23° C. before it is broken, thereby determining the Young's modulus, the elongation at break and the tensile strength at break of the sample. The chuck-to-chuck distance is 60 mm, and the crosshead speed is 5 mm/min.
(3) thermal expansion coefficient:

The sheet-like molding is cut into a piece of 3 mm×25 mm, and this is set in a TMA device (trade name “TMA/SS120C” by Seiko Electronics) and heated from23° C. up to 150° Cat a heating rate of 5° C./min. The mean linear expansion coefficient of the sample is derived from the temperature profile thereof.

TABLE 1

| | | | | | | Linear |
|---|---|---|---|---|---|---|
| | | | Young's | | Tensile | Expansion |
| | Dielectric | Dielectric | Modulus | Elongation at | Strength at | Coefficient |
| | Constant | Loss Tangent | (GPa) | break (%) | break (MPa) | (×10⁻⁶) |
| Example 1 | 3.0 | 0.012 | 4.0 | 2.9 | 74 | 70 |
| Example 2 | 2.8 | 0.010 | 3.5 | 7.0 | 73 | 84 |
| Example 3 | 2.8 | 0.008 | 3.7 | 21.0 | 85 | 64 |
| Example 4 | 3.1 | 0.013 | 4.0 | 2.5 | 79 | 85 |
| Example 5 | 3.1 | 0.010 | 4.6 | 2.0 | 77 | 59 |
| Example 6 | 2.8 | 0.006 | 4.5 | 3.1 | 79 | 47 |
| Comparative | 3.3 | 0.019 | 3.0 | 1.9 | 60 | 91 |
| Example 1 | | | | | | |

What is claimed is:

1. A thermosetting resin composition comprising an epoxy compound and a bifunctional dihydrobenzoxazine compound of the following general formula (1), wherein the equivalent ratio of the epoxy compound to the bifunctional dihydrobenzoxazine compound is 1/(0.1 to 20): 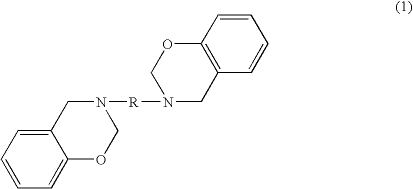
wherein R represents a linear alkylene group having at least 2 carbon atoms, or a branched alkylene group derived from it by substituting the hydrogen atom therein with an alkyl group, and the hydrogen atom of the benzene ring may be substituted with an alkyl group or an alkoxy group.

2. A thermosetting resin molding produced by thermally molding the thermosetting resin composition of claim 1.

3. The thermosetting resin molding as claimed in claim 2, which has a dielectric constant of at most 3.5 and a dielectric loss tangent of at most 0.015, at 23° C. at 1 GHz.

4. The thermosetting resin molding as claimed in claim 2, which has a Young's modulus at 23° C. from 0.5 to 5.5 GPa, and has an elongation at break at 23° C. from 2.0 to 40%.

5. A thermosetting resin composition comprising an epoxy compound, a bifunctional dihydrobenzoxazine compound of the following general formula (1) and a curing agent for epoxy compound, wherein the equivalent ratio of epoxy compound/bifunctional dihydrobenzoxazine compound/curing agent for epoxy compound is 1/(0.1 to 20)/(0 to 1.2): 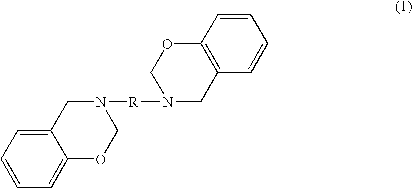
wherein R represents a linear alkylene group having at least 2 carbon atoms, or a branched alkylene group derived from it by substituting the hydrogen atom therein with an alkyl group, and the hydrogen atom of the benzene ring may be substituted with an alkyl group or an alkoxy group.

6. A thermosetting resin molding produced by thermally molding the thermosetting resin composition of claim 5.

7. The thermosetting resin molding as claimed in claim 6, which has a dielectric constant of at most 3.5 and a dielectric loss tangent of at most 0.015, at 23° C. at 1 GHz.

8. The thermosetting resin molding as claimed in claim 6, which has a Young's modulus at 23° C. from 0.5 to 5.5 GPa, and has an elongation at break at 23° C. from 2.0 to 40%.

9. A thermo setting resin composition comprising an epoxy compound, a bifunctional dihydrobenzoxazine compound of the following general formula (1) and an inorganic filler, wherein the equivalent ratio of the epoxy compound to the bifunctional dihydrobenzoxazine compound is 1/(0.1 to 20), and the amount of the inorganic filler is at most 400 parts by weight relative to 100 parts by weight of the total of the epoxy compound and the bifunctional dihydrobenzoxazine compound: 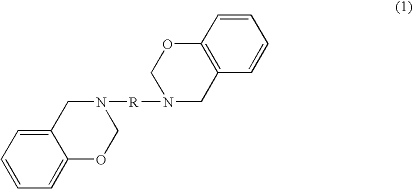
wherein R represents a linear alkylene group having at least 2 carbon atoms, or a branched alkylene group derived from it by substituting the hydrogen atom therein with an alkyl group, and the hydrogen atom of the benzene ring may be substituted with an alkyl group or an alkoxy group.

10. A thermosetting resin molding produced by thermally molding the thermosetting resin composition of claim 9.

11. The thermosetting resin molding as claimed in claim 10, which has a dielectric constant of at most 3.5 and a dielectric loss tangent of at most 0.015, at 23° C. at 1 GHz.

12. The thermosetting resin molding as claimed in claim 10, which has a Young's modulus at 23° C. from 0.5 to 5.5 GPa, and has an elongation at break at 23° C. from 2.0 to 40%.

13. A thermosetting resin composition comprising an epoxy compound, a bifunctional dihydrobenzoxazine compound of the following general formula (1), a curing agent for epoxy compound and an inorganic filler, wherein the equivalent ratio of epoxy compound/bifunctional dihydrobenzoxazine compound/curing agent for epoxy compound is 1/(0.1 to 20)/(0 to 1.2), and the amount of the inorganic filler is at most 400 parts by weight relative to 100 parts by weight of the total of the epoxy compound, the bifunctional dihydrobenzoxazine compound and the curing agent for epoxy resin: 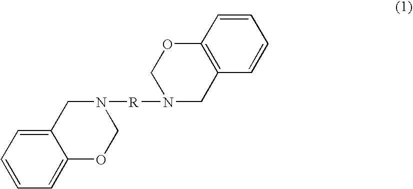
wherein R represents a linear alkylene group having at least 2 carbon atoms, or a branched alkylene group derived from it by substituting the hydrogen atom therein with an alkyl group, and the hydrogen atom of the benzene ring may be substituted with an alkyl group or an alkoxy group.

14. A thermosetting resin molding produced by thermally molding the thermosetting resin composition of claim 13.

15. The thermosetting resin molding as claimed in claim 14, which has a dielectric constant of at most 3.5 and a dielectric loss tangent of at most 0.015, at 23° C. at 1 GHz.

16. The thermosetting resin molding as claimed in claim 14, which has a Young's modulus at 23° C. from 0.5 to 5.5 GPa, and has an elongation at break at 23° C. from 2.0 to 40%.
